(19) United States
(12) Patent Application Publication
(10) Pub. No.: US 2005/0042021 A1
(43) Pub. Date: Feb. 24, 2005

(54) Obituary organizer

(76) Inventor: Franklin Delano McArthur JR., Mount Laurel, NJ (US)

Correspondence Address: Franklin Delano McArthur Jr, 1501 Saxony Drive, Mount Laurel, NJ, 08054, US

(21) Appl. No.: 10/777,274

(22) Filed: Feb. 12, 2004

Related U.S. Application Data
(60) Provisional application No. 60/447,338, filed on Feb. 14, 2003.

(51) Int. Cl. B42F 3/00

(52) U.S. Cl. 402/70

(57) ABSTRACT

A rounded top headstone shaped loose-leaf ring binder, with the ring assembly attached to the right edge of the inside back cover. A transparent horizontally loading folded sheet protector, with a ½″ ring retaining extension on the right edge of the back panel, was designed to mount onto the rings of this binder. The sheet protector will enable the viewer to view the front, inside and back of a folded 8½″×11″ paper document folded in half.

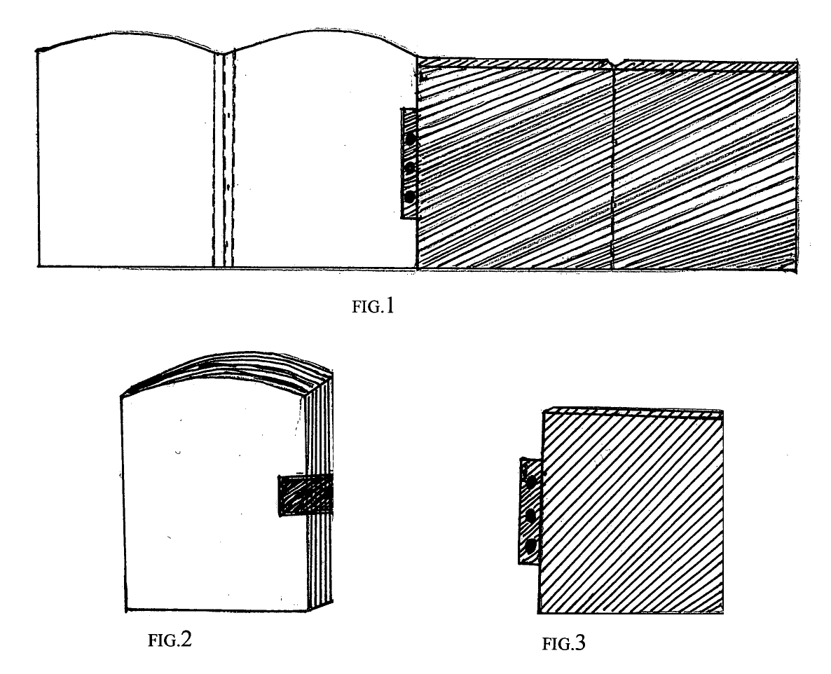

The Obituary Organizer claims the benefit of a prior Provisional Patent Application No. 60/447,338 filed on Feb. 2, 2003. The Obituary Organizer consist of two units, a one-piece tombstone shaped binder, and twenty-five clear plastic top loading page protectors. When the binder is opened it measures 9½″×12″ with a 1″ flexible space in the middle to compliment the pages when there folded in half. The binder has a 1″×4″ Velcro locking device in the middle on the right edge of the front cover.

The first unit is the binder, it's made of recycled corrugated cardboard and can be covered with leather, plastic, velvet or cloth etc. The invention's title will be emblazoned on the outside of the front cover. The second unit is the twenty-five clear plastic top loading page protectors. The pages are 8½″×11″ with a single built-in 6″ extension on the right edge. The extension can be 3-ring holes, solid for rivets or is Velcroed on the top (facing upward). If Velcro is used on the extension, then a 6″ Velcro attachment will be attached to the right edge of the inside back cover panel.

Each page has an unsealed crease down the middle. The crease will make it easier to fold the pages in half, so that the binder will close like a book.

When a funeral obituary program is inserted into a page protector, the entire program will be readable without removing it from its protector.

What I claim is my invention is: Multiple top loading page protectors attached to the right edge of a single built-in extension, that extension is then folded to the left and attached from the inside out, to the right edge of a tombstone shaped binder.

### STATEMENT REGARDING FEDERALLY SPONSORED RESEARCH OR DEVELOPMENT

Not Applicable

### REFERENCE TO SEQUENCE LISTING A TABLE, OR COMPUTER PROGRAM LISTING COMPACT DISC APPENDIX

Not Applicable

### BACKGROUND OF THE INVENTION

The Obituary Organizer was invented as a Funeral Director's Advertising Gift, and for the infinite number of people who collect for posterity the funeral obituary programs of deceased family members, friends, acquaintances & pets.

Every obituary program has a minute detailed account of a person's life and their family's pass and present history. The organizing of a family's decease family tree can be a very useful reference, when tracing one's ancestry and their burial site locations. The Obituary organizer is a memorial and grief-related product. Unlike the old gift calendar advertisement, this is the ultimate Funeral Directors Advertising Gift, It's unique and eternal. It provides the means to pay tribute to one's history whenever one feels the need to do so. It gives reason to rounding up, organizing, storing and preserving those precious funeral obituary programs.

Family reunion organizer's can collect the deceased family member's obituary programs, reproduce and organized them into multiple Obituary Organizer's and present them as gifts at family reunions. This will help assure that a family's legacy will live on indefinitely.

The U.S. patent Classification Definition 402—BINDER DEVICE RELEASABLY ENGAGING APERTURE OR NOTCH OF SHEET (1) A device including a sheet retainer* in the form of means which passes through the thickness dimension of a sheet* or a group of sheets to secure the same in either geometrically congruent relation or in haphazard arrangement and cooperates with structure (e.g., hold, peripheral incised opening, etc.) of the sheet(s) to releasably retain such sheet(s) therein or thereto in such a manner that removal thereof, in the manner intended, from the means may be accomplished without mutilation (e.g., tearing, deforming, etc.) of any portion of either the means or the sheet(s). (2) such sheet retainer, per se. (3) A depository* or other perfecting feature intended for attachment to and serving to perfect a sheet retainer* and it's proximate function as set forth under (1) above or (4) A sheet, per se, notched or apertured to accommodate a sheet retainer of this class.

### BRIEF SUMMARY OF THE INVENTION

The Obituary Organizer was invented to give people a special device to store funeral obituary programs in, and to help increase the profitability of the funeral directors business by using it as an advertising gift. Presently there is no depository or sheet retainer on the market invented specifically for the retention, preservation, and organizing of funeral obituary programs.

### BRIEF DESCRIPTION OF THE SEVERAL VIEWS OF THE DRAWING

FIG.
1. The Obituary Organizer's one piece binder cover with flexible space in the middle, is attached to the clear plastic top loading page protectors is completely laid open, exposing the single build-in extension attached from the inside out, to the right edge of the inside back cover panel. The pages have an unsealed crease down the middle. The pages can be attached to the binder with rivets, rinds or Velcro etc.
2. The clear plastic top loading page protectors folds to the left of the built-in extension, then the binder with pages included closes like a book.

FIG.
3. Front page view suitable for the illustration and publication of the invention.
4. The Velcro locking device is just a positive and negative strip of Velcro.
5. The combined twenty-five clear plastic top loading page protectors, attached to a single built-in extension.

FIG.
6. A single clear plastic top loading page protector with a built-in extension on it's right edge is flipped over, to view the proper inside out attaching angle.

### DETAILED DESCRIPTION OF THE INVENTION

The Obituary Organizer is a binder made from recycled corrugated cardboard and shaped like a typical white marble military headstone. It has a ½″×6″ Velcro strip centered on the right edge of the inside back panel cover. There's also a 1″×3½″ Velcro locking device centered on the right edge of the front cover that extends around to the back cover and locks. Inside there's twenty-five 8½″×11″ clear plastic top loading page protectors combined to a single built-in extension on the right edge of the pages, there's also an unsealed crease down the middle of each page. A ½″×6″ Velcro strip is also attached to the pages extension, facing upward. There's a ½″ crease to the left of the extended, the entire 6″. The twenty-five page built-in extension folds under from right to left, and is attached permanently or temporarily with Velcro, rivets or rings etc., to the right edge of the inside back panel cover. The total amount pages can also be upgraded.

The Binder cover can be covered with leather, velvet, cloth or plastic etc.

The Obituary Organizer is the only organizer in the world to address the problem of storing, preserving and organizing Funeral Obituary Programs. The Obituary Organizer can be used to memorialize the memories of family members, friends and pets for posterity. Genealogist will find that organizing and categorizing obituary programs can aid in the tracing of one's ancestry, and the location of their burial sites.

The manufacture of the Obituary Organizer can be accomplished by any Scrapbook Manufacturing Company with little to no retooling. That also applies to the manufacturing of the combined twenty-five 8½″×11″ clear plastic top loading pages protectors with a single built-in extension. The Obituary Organizer was invented to act as a Funeral Obituary & Deceased Family Tree Organizer.

1. A rounded top headstone shaped loose-leaf ring binder, with said ring assembly attached to the right edge of the inside of, said ring binder's back cover.

2. A transparent horizontally loading folded sheet protector for holding an 8½″×11″ paper document folded in half, said sheet protector comprising:
a) An unwelded vertical folding crease down the middle.
b) A ½″ ring retaining extension with holes on the right edge of said sheet protector.
c) The left edge of, said sheet protector is folded from left to right to align with the right edge, with said extension extending beyond said folded sheet protector, defining said horizontally loading folded sheet protector.
d) When said sheet protector is mounted onto, said ring binder's rings with said folded paper document inserted, it enables the user to view the entire front of said document, view the inside contents and to turn, said document to the right onto it's face to view the back. Thus allowing said folded paper documents to be chronologically organized, stored and preserved.
